(19) United States
(12) Patent Application Publication
(10) Pub. No.: US 2023/0421556 A1
(43) Pub. Date: Dec. 28, 2023

(54) DISTRIBUTION OF SECURE CLIENT DEVICES

(71) Applicant: FinWorld, Inc., West Des Moines, IA (US)

(72) Inventors: Mark Gremler, Cumming, IA (US); Scott Pappan, Pleasant Hill, IA (US)

(21) Appl. No.: 18/338,547

(22) Filed: Jun. 21, 2023

Related U.S. Application Data
(60) Provisional application No. 63/354,392, filed on Jun. 22, 2022.

(51) Int. Cl. H04L 9/40; H04L 67/143

(52) U.S. Cl. CPC H04L 63/0876; H04L 63/102; H04L 67/143

(57) ABSTRACT

A method for distributing at least one client device is disclosed. The method can include establishing a fiduciary relationship between a financial entity and a client and programming the at least one client device such that the at least one client device is configured to establish communication with authorized third-party institutions via an extranet once the client has provided authentication credentials. The method can also include issuing the client device to the client.

### BACKGROUND

Cloud computing comprises the on-demand availability of computer resources without direct active management by a user. Further, cloud computing systems can be distributed over multiple locations. Various computing devices, or client devices, can communicate with the cloud computing systems and provide specific data to the connected client devices.

### SUMMARY

A method for distributing at least one client device is disclosed. The method can include establishing a fiduciary relationship between a financial entity and a client and programming the at least one client device such that the at least one client device is configured to establish communication with authorized third-party institutions via an extranet once the client has provided authentication credentials. The method can also include issuing the client device to the client.

In other features, the at least one client device is configured to establish a secure communication channel with the financial entity.

In other features, the extranet is configured to access only webpages corresponding to the financial entity.

In other features, the at least one client device is configured to render all data on a hard drive of the at least one client devices unreadable in response to receiving a termination command.

In other features, the authentication credentials comprise at least one of a financial entity identification, a media access control (MAC) address of the at least one client device, or a portal identifier.

In other features, the financial entity identification comprises at least one of a financial broker-dealer, a financial broker, a financial dealer, or a financial adviser.

In other features, a specification platform is configured to prevent the at least one client device from accessing an unauthorized webpage via the extranet.

In other features, the specification platform is configured to redirect an unauthorized request from the at least one client device.

A method is disclosed that includes receiving an authentication request from a client device, determining whether the authentication request is valid, determining at least one extranet associated with the authentication request after determining the authentication request is valid, and providing access to the at least one extranet.

In other features, the method includes accessing an authentication identifier stored in a data structure based on the authentication request, and selecting the at least one extranet based on the authentication identifier

In other features, the authentication identifier corresponds to the at least one extranet.

In other features, the at least one extranet corresponds to a financial institution.

In other features, the financial institution comprises at least one of a financial broker-dealer, a financial broker, a financial dealer, or a financial advisor.

In other features, the method includes receiving a termination request, and in response to the termination request, transmitting a termination command to at least one client device, wherein the termination command causes the at least one client device to cease operation.

A system is disclosed that includes a computer including a processor and a memory. The memory including instructions such that the processor is programmed to: receive an authentication request from a client device, determine whether the authentication request is valid, determine at least one extranet associated with the authentication request after determining the authentication request is valid, and provide access to the at least one extranet.

In other features, the processor is further programmed to access an authentication identifier stored in a data structure based on the authentication request, and select the at least one extranet based on the authentication identifier.

In other features, the authentication identifier corresponds to the at least one extranet.

In other features, the at least one extranet corresponds to a financial institution.

In other features, the financial institution comprises at least one of a financial broker-dealer, a financial broker, a financial dealer, or a financial advisor.

In other features, the processor is further programmed to receive a termination request, and in response to the termination request, transmit a termination command to at least one client device, wherein the termination command causes the at least one client device to cease operation.

### BRIEF DESCRIPTION OF THE DRAWINGS

FIGS. 1A through 1E illustrate example environments for provisioning a secure client device between a broker-dealer and another financial institution.

FIG. 1F is a diagram of an example system for providing access to a particular extranet within a computing environment.

FIG. 2 is a diagram of an example client device.

FIG. 3 is a diagram of another example system for providing access to a particular extranet within a computing environment.

FIG. 4 is a graphical representation of a login portal.

FIGS. 5A through 5K are graphical representations of webpages presented to a user via a client device, where the webpages present services corresponding to a particular extranet.

FIG. 6 is a flow diagram illustrating a process for distributing secure client devices to one or more users.

FIG. 7 is a flow diagram illustrating a process for authenticating a client device.

FIG. 8 is a flow diagram illustrating a process for transmitting a termination command to one or more client devices.

### DETAILED DESCRIPTION

### Overview

Within many business relationships, it is desirable to distribute secure client devices to multiple parties having a business relationship with an entity. For example, a financial broker-dealer may distribute secure client devices to one or more financial entities through a financial transaction. In turn, the financial entities can distribute these secure client devices to clients. For instance, the financial entities can distribute these secure client devices to clients in which the financial entity has a fiduciary relationship with the client.

The secure client device only allows users, i.e., clients, to access a particular extranet associated with the financial entity. For example, an extranet may be created and associated with a specific financial entity, and the extranet only allows users to access third-party portals associated with the specific financial entity once the user provides suitable credentials for authorization purposes. The user of the secure client device can also access an intranet. The intranet can be used to store user documents, such as legal documents, financial documents, and the like. By limiting access to only particular extranets and intranets, security issues can be mitigated. For example, in only allowing users to access particular extranets, users are less likely to encounter websites and/or portals having malware and/or computer viruses.

Within the present context, a particular entity can control operational capabilities of the secure client device. For example, the financial broker-dealer may establish a licensing agreement with the financial entity for distribution, i.e., issuance, of the secure client devices. Upon termination of the licensing agreement, the financial broker-dealer can cause a termination command to the distributed secure client devices such that the secure client devices are no longer operational.

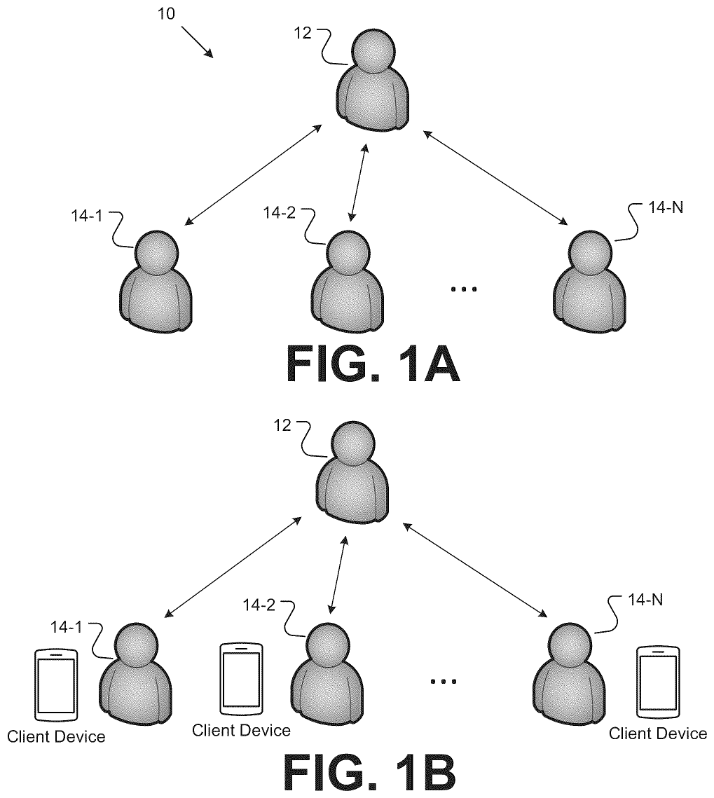

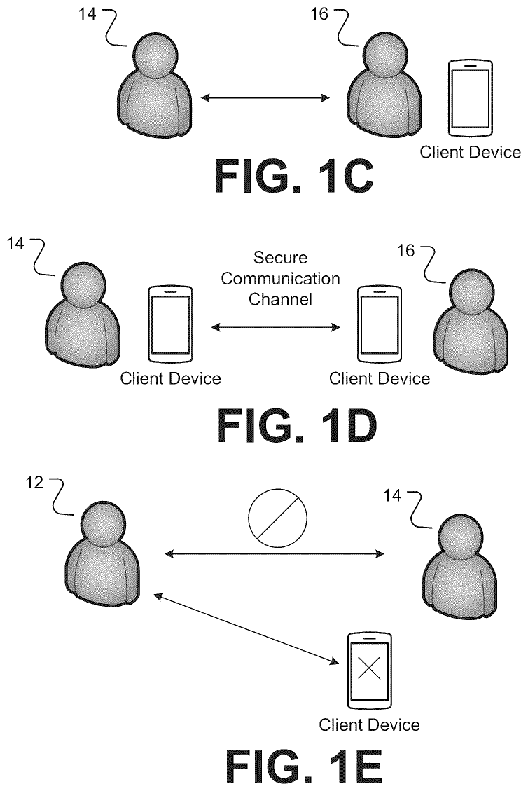

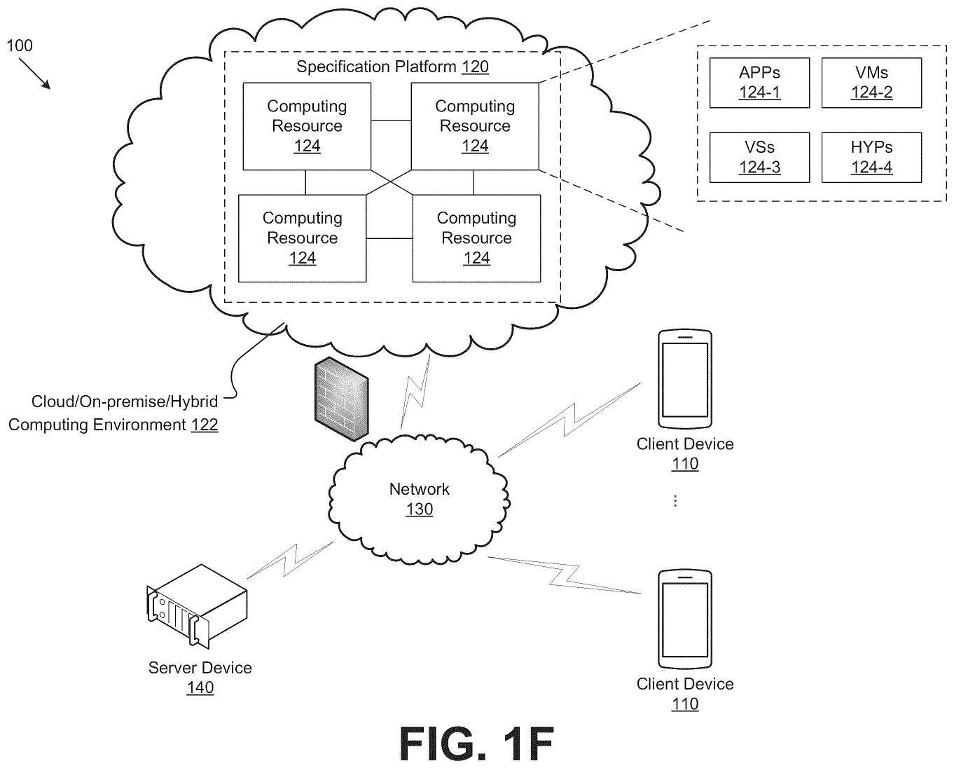

FIG. 1A illustrates an example environment 10 that includes a broker-dealer 12 that has a relationship with one or more financial entities 12-1 through 12-N, where N is an integer greater than or equal to 2. The financial entities 14-1 through 14-N can comprise financial brokers, financial dealers, financial advisors, and the like. For example, the financial entities 14-1 through 14-N may have established a contractual relationship with the broker-dealer 12. With the present context, as shown in FIG. 1B, the broker-dealer 12 has provided each financial entity 14-1 through 14-N with a secure client device based on the relationship.

As shown in FIG. 1C, the financial entity 14 can provide a client 16 with the secure client device. For instance, the financial entity 14 may be a financial advisor or a broker for the client 16. As described in greater detail herein, the secure client device is configured such that the client 16 has limited access to particular extranets and intranets associated with financial entity 14. For example, the secure client device may allow the client 16 to upload financial documents, family documents, and the like via the intranet portion and access authorized third-party institutions via the extranet portion.

In some instances, as shown in FIG. 1D, the client 16 can establish a secure communication channel with the financial entity 14 via the secure client device. For example, the secure client device can be preprogrammed to include a cloud-based video communications application that is preset with the financial entity's 14 contact information. In other words, the cloud-based video communications application can be preprogrammed with authorized contacts.

Referring to FIG. 1E, the broker-dealer 12 can cause can render all data on a hard drive of the secure client device unreadable when the relationship between the broker-dealer 12 and the financial entity 14 terminates. For example, if a contractual relationship between the broker-dealer 12 and the financial entity 14 ceases, the broker-dealer 12 can contact a technical administrator to cause client devices associated with the financial entity 14 to be nonfunctional.

While the present disclosure provides examples related to financial entities, it is understood that the present disclosure can extend to other business entities as well. For example, secure client devices can be supplied within a medical environment in which the medical entity, i.e., medical facility, issues the secure client devices to medical personnel associated with the medical entity. In another example, secure client devices can be supplied within a legal environment in which the legal entity, i.e., law firm, issues the secure client devices to legal personnel associated with the legal entity.

Thus, the present disclosure is directed to a system for securing data and protecting the exchange of information between parties. For example, the system can include a secure client device that is issued to a client of a financial broker-dealer. The client device can be configured such that, once authenticated, the client device can access a particular extranet associated with the financial broker-dealer. In other words, the client device is configured to only allow a user of the client device to access a particular extranet such that potential security threats to the client device are mitigated. The client device can also allow the user to securely communicate with the financial broker-dealer.

### System

FIG. 1F illustrates an example environment 100 that includes one or more client devices 110, a specification platform 120, and a network 130, and a server device 140. Devices of environment 100 may interconnect via wired connections, wireless connections, or a combination of wired and wireless connections.

Client device 110 includes one or more devices capable of receiving, generating, storing, processing, and/or providing information associated with an account and/or a transaction for which the account is to be used. For example, client device 110 may include a desktop computer, a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device.

Specification platform 120 includes one or more devices that authorize client devices 110 and provide access to an intranet and/or selected extranets after authorization of client devices 110. In some implementations, specification platform 120 may be designed to be modular such that certain software components may be swapped in or out depending on a particular need. As such, specification platform 120 may be easily and/or quickly reconfigured for different uses. In some implementations, specification platform 120 may receive information from and/or transmit information to one or more client devices 110 and/or server devices 140.

In some implementations, as shown, specification platform 120 may be hosted in a cloud computing environment 122, an on-premise computing environment, a hybrid (e.g., on-premise and cloud-based) computing environment, and/or the like. Notably, while implementations described herein describe specification platform 120 as being hosted in cloud computing environment 122, in some implementations, specification platform 120 may not be cloud-based (i.e., may be implemented outside of a cloud computing environment) or may be partially cloud-based.

Cloud computing environment 122 includes an environment that hosts specification platform 120. Cloud computing environment 122 may provide computation, software, data access, storage, etc., services that do not require end-user knowledge of a physical location and configuration of system(s) and/or device(s) that hosts specification platform 120. As shown, cloud computing environment 122 may include a group of computing resources 124 (referred to collectively as “computing resources 124” and individually as “computing resource 124”).

Computing resource 124 includes one or more personal computers, workstation computers, mainframe devices, or other types of computation and/or communication devices. In some implementations, computing resource 124 may host specification platform 120. The cloud resources may include compute instances executing in computing resource 124, storage devices provided in computing resource 124, data transfer devices provided by computing resource 124, etc. In some implementations, computing resource 124 may communicate with other computing resources 124 via wired connections, wireless connections, or a combination of wired and wireless connections.

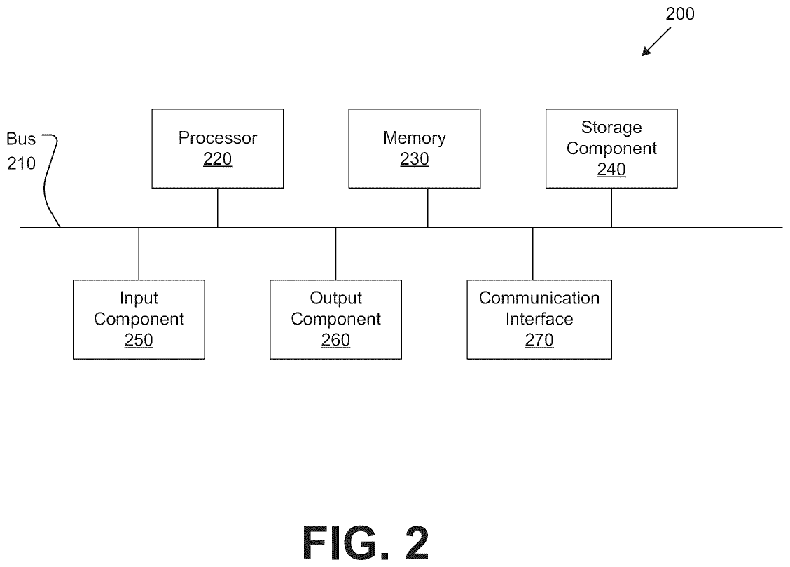

As further shown in FIG. 2, computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, and/or the like.

Application 124-1 includes one or more software applications that may be provided to or accessed by client device 210 and/or server device 140. Application 124-1 may eliminate a need to install and execute the software applications on client device 210. For example, application 124-1 may include software associated with specification platform 120 and/or any other software capable of being provided via cloud computing environment 122. In some implementations, one application 124-1 may send/receive information to/from one or more other applications 124-1, via virtual machine 124-2.

Virtual machine 124-2 includes a software implementation of a machine (e.g., a computer) that executes programs like a physical machine. Virtual machine 124-2 may be either a system virtual machine or a process virtual machine, depending upon use and degree of correspondence to any real machine by virtual machine 124-2. A system virtual machine may provide a complete system platform that supports execution of a complete operating system. A process virtual machine may execute a single program and may support a single process. In some implementations, virtual machine 124-2 may execute on behalf of a user (e.g., a user of client device 210 or an operator of specification platform 120), and may manage infrastructure of cloud computing environment 122, such as data management, synchronization, or long-duration data transfers.

Virtualized storage 124-3 includes one or more storage systems and/or one or more devices that use virtualization techniques within the storage systems or devices of computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 124-4 may provide hardware virtualization techniques that allow multiple operating systems (e.g., “guest operating systems”) to execute concurrently on a host computer, such as computing resource 124. Hypervisor 124-4 may present a virtual operating platform to the guest operating systems and may manage the execution of the guest operating systems. Multiple instances of a variety of operating systems may share virtualized hardware resources.

Computing resource 124 can also include one or more data structures associated with the specification platform 120. In an example implementation, the data structure can comprise one or more of a database, a table, a list, and/or the like. The data structure may be stored in virtualized storage (“VSs”) 124-3, or the like.

Network 130 includes one or more wired and/or wireless networks. For example, network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, an extranet, the Internet, a fiber optic-based network, and/or the like, and/or a combination of these or other types of networks.

Server device 140 includes one or more devices capable of receiving, generating, storing, processing, and/or providing information, such as information described herein. For example, server device 140 may include a laptop computer, a tablet computer, a desktop computer, a group of server devices, or a similar type of device. In some implementations, server device 140 may receive information from and/or transmit information to client device 210 and/or specification platform 120. In some implementations, the server device 140 comprises a computing resource associated with a third-party institution. For example, the third-party institution may be a financial institution, a government institution, a financial adviser, or the like.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 2 is a diagram of example components of a device 200. Device 200 may correspond to client device 110, specification platform 120, computing resource 124, and/or server device 140. In some implementations, client device 110, specification platform 120, computing resource 124, and/or server device 140 may include one or more devices 200 and/or one or more components of device 200. As shown in FIG. 2, device 200 may include a bus 210, a processor 220, a memory 230, a storage component 240, an input component 250, an output component 260, and a communication interface 270.

Bus 210 includes a component that permits communication among the components of device 200. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 220 includes one or more processors capable of being programmed to perform a function. Memory 230 includes a random-access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of device 200. For example, storage component 240 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits device 200 to receive information, such as via user input (e.g., a touch screen display, a keyboard, a keypad, a mouse, a button, a switch, and/or a microphone). Additionally or alternatively, input component 250 may include a sensor for sensing information (e.g., a global positioning system (GPS) component, an accelerometer, a gyroscope, and/or an actuator). Output component 260 includes a component that provides output information from device 200 (e.g., a display, a speaker, and/or one or more light-emitting diodes (LEDs)).

Communication interface 270 includes a transceiver-like component (e.g., a transceiver and/or a separate receiver and transmitter) that enables device 200 to communicate with other devices, such as via a wired connection, a wireless connection, or a combination of wired and wireless connections. Communication interface 270 may permit device 200 to receive information from another device and/or provide information to another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

Device 200 may perform one or more processes described herein. Device 200 may perform these processes based on processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

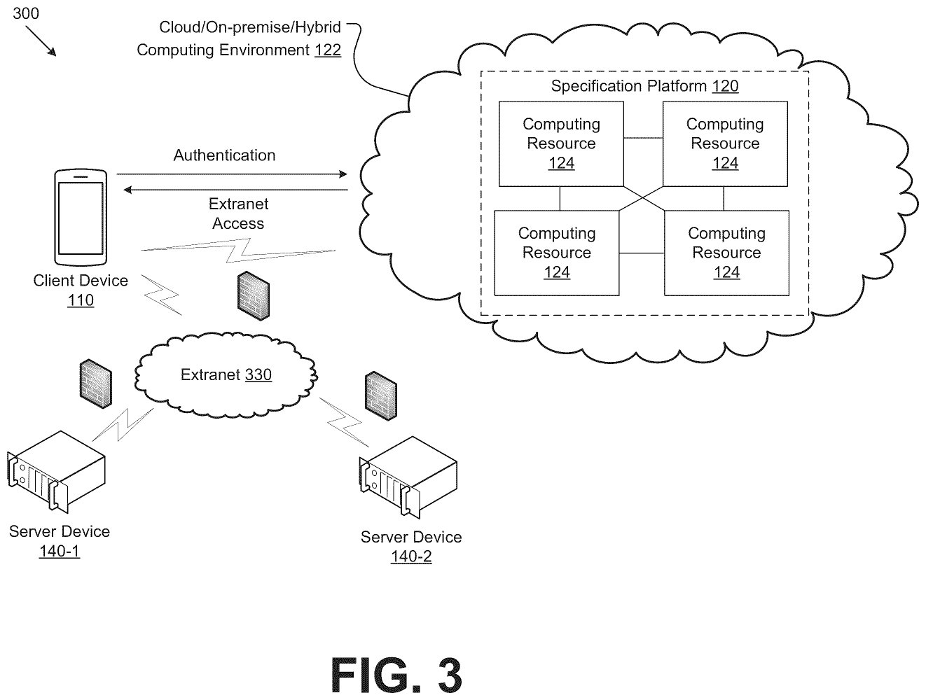

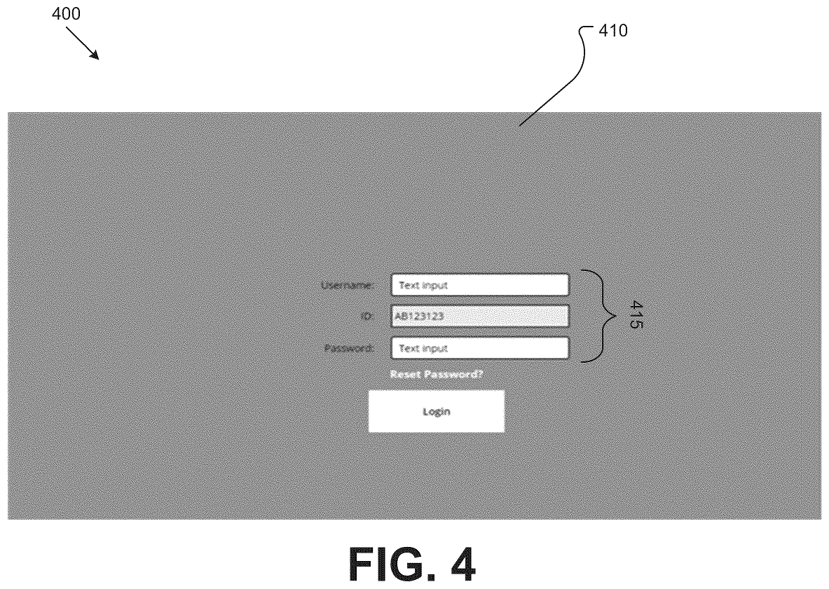

FIG. 3 illustrates an example environment 300 that includes client device 100, specification platform 120, server device 140-1, and server device 140-2. In this implementation, specification platform 120 provides authentication services to allow client device 110 to access extranet 330. Extranet 330 comprises a closed private network that is accessible to authenticated parties, which is described in greater detail below with reference to FIGS. 4 through 8. Client device 110 may further include password managers such that the user can access third-party institution data once authenticated. For example, password managers can be used to store user credentials for particular third-party institutions.

Once authenticated, client device 110 can communicate with server devices 140-1, 140-2. In this implementation, server device 140-1 can comprise a first third-party institution, such as a financial institution, and server device 140-2 can comprise a second third-party institution, such as a financial advisor. Within this context, extranet 330 has been configured to allow authenticated client devices 110 to access websites of predetermined third-party institutions. For example, extranet 330 can be configured to only allow access to certain third-party institutions to mitigate security threats, such as malware. It is understood that the environment 300 can include multiple extranets 330 that each correspond to an approved entity. The entity may comprise a financial entity that establishes a fiduciary relationship with a user.

In some implementations, a firewall may be used to prevent communication between client devices 110 and unauthorized third-party institutions. For example, the firewall may only allow communication to be transmitted to and/or received from domains corresponding to authorized third-party institutions. In other implementations, client devices 110 may use application programming interfaces (APIs) corresponding to authorized third-party institutions. For example, authorized application programming interfaces may only permit users from accessing domains corresponding to authorized third-party institutions. In yet other implementations, specification platform 120 implements uniform resource locator (URL) redirect techniques to prevent communication between client devices 110 and unauthorized third-party institutions. For example, in the event a user attempts access an unauthorized website, specification platform 120 implements URL redirection, i.e., forwarding, to redirect a request from client device 110 to an approved website, such as an intranet homepage.

In various implementations, specification platform 120 can be configured to store death and/or disability directives for users of client device 110. For example, in the event that a user dies or becomes incapacitated, specification platform 120 can transfer credentials and/or digital assets from user to a designated party per the stored directive.

FIG. 4 illustrates an example login screen 410 presented to a user for authentication purposes. Login screen 410 can be presented to the user via output component 260 of client device 110 and can be generated using suitable applications (“apps”) and/or customer relationship management software (CMS). Login screen 410 is part of a web portal that allows authenticated users to access extranet 330 via client device 110. In an example implementation, the user of client device 110 can be authenticated by entering the user's credentials into the login screen 410. Credentials can include, but are not limited to, user identification, password, and/or financial entity-broker identification. For instance, as shown in FIG. 4, a user can input the requisite credentials in input fields 415. Once initiated, a login script can authenticate the credentials via suitable border network functions (BNFs).

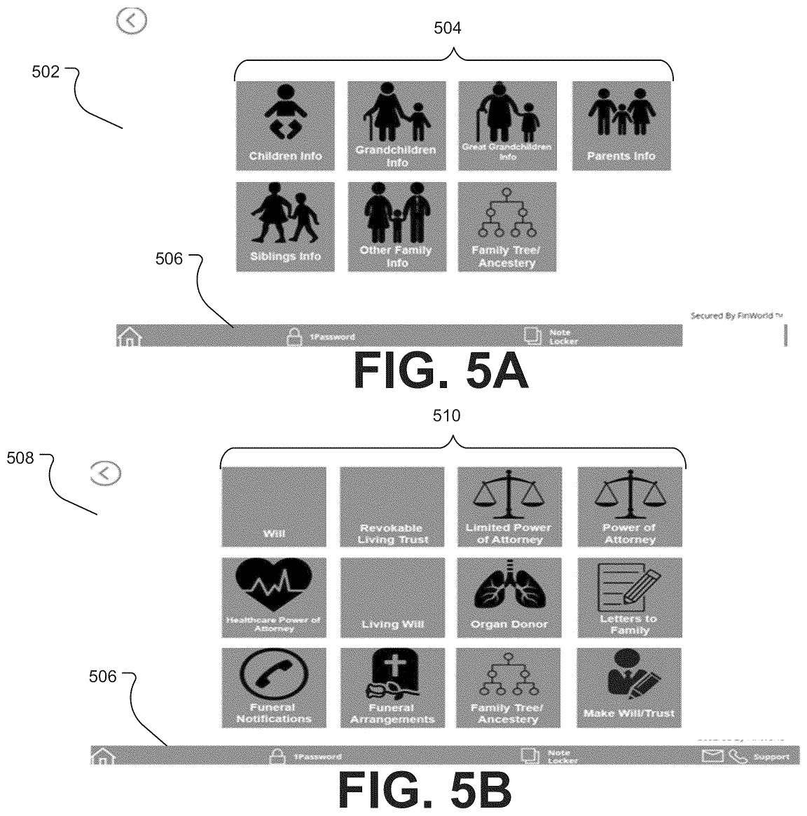

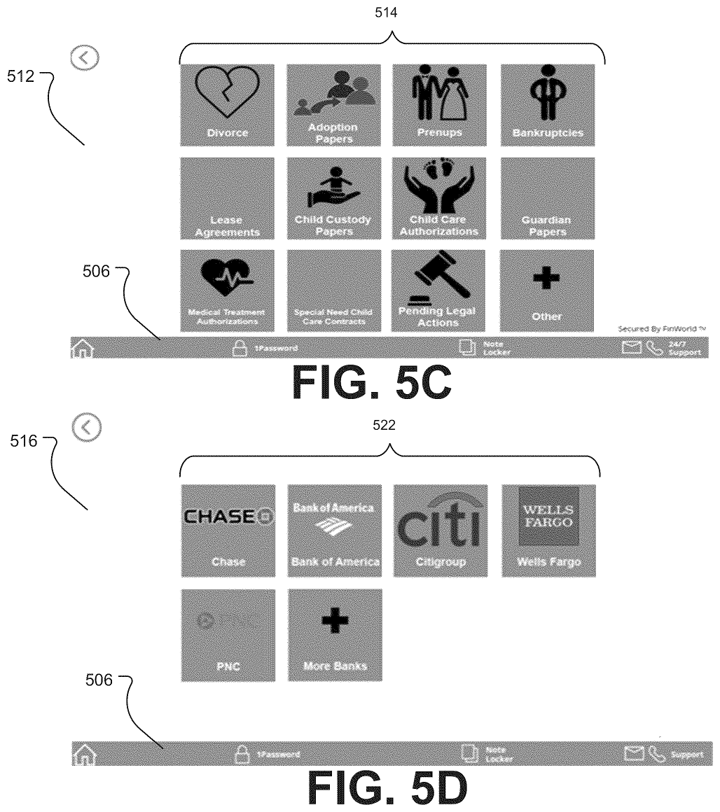

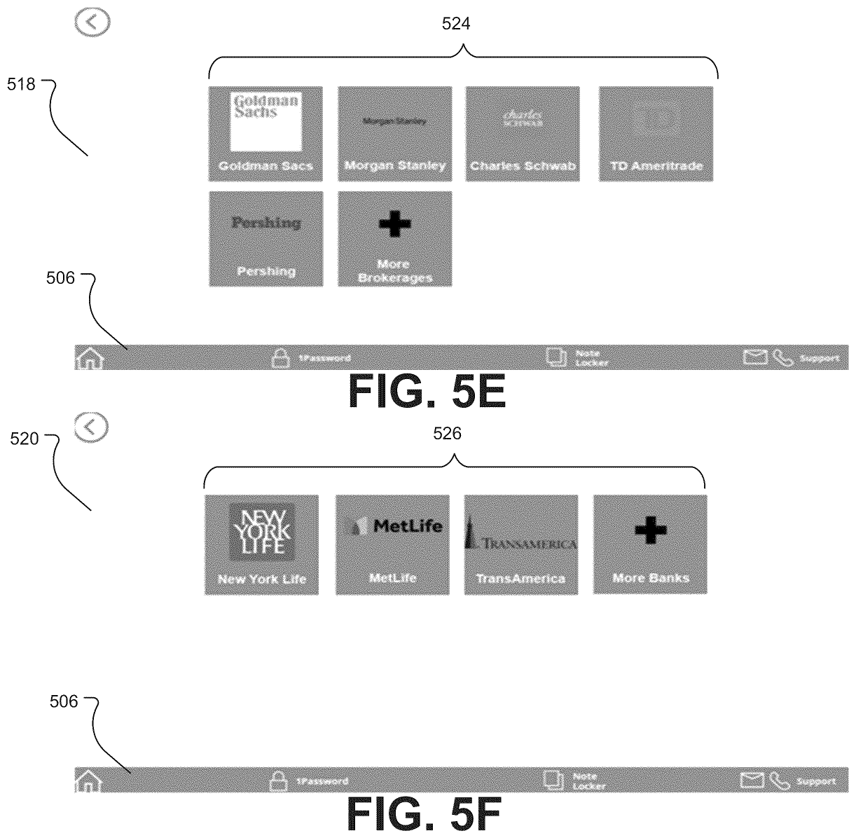

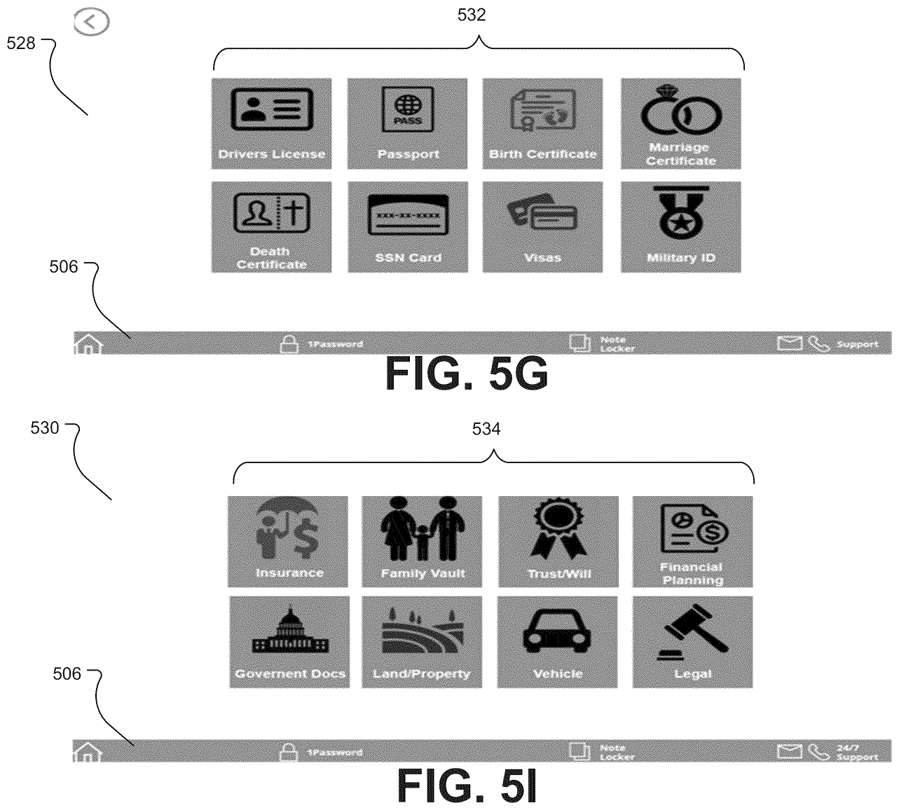

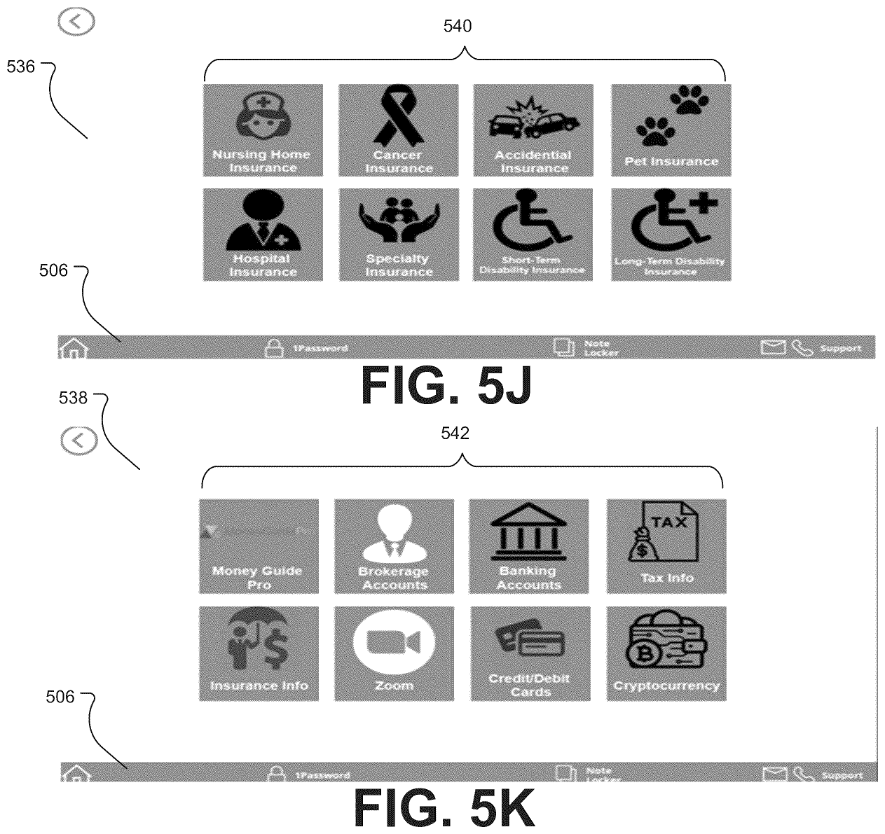

FIGS. 5A through 5K illustrate example webpages presented to the user upon successful authentication. The webpages are configured to provide access to extranet 330 and/or intranet. As discussed herein, extranet 330 can correspond to a particular financial broker-dealer and/or financial institution, e.g., broker, dealer, financial advisor, etc. As such, extranet 330 is configured to only provide access to services associated with the particular financial institution and/or the particular financial broker-dealer.

FIG. 5A illustrates an example webpage 502 illustrating multiple tiles 504 presented to the user. The user can interface with one or more of the tiles 504 to access one or more portions of the intranet associated with the user's family. More specifically, as discussed herein, the user can upload relevant documents to specification platform 120 for storage. The uploaded documents can be organized such that the user can query for specific documents via the appropriate tiles 504. As shown, the tiles 504 in FIG. 5A correspond to children information, grandchildren information, great grandchildren information, parent information, sibling information, other family information, and family tree/ancestry information. Webpage 502 can further include a ribbon 506 that allows the user to return to a home page, to access a password manager, access a text editing application, and establish communication for support purposes, i.e., a cloud-based communications application.

FIGS. 5B and 5C illustrate example webpages 508, 512 illustrating respective multiple tiles 510, 514 presented to the user to allow the user to access one or more portions of the intranet associated with the user. As shown, the tiles 510, 514 can provide access to end-of-life directives, repositories for personal statements, family documents, and the like.

FIGS. 5D through 5F illustrate example webpages 516, 518, 520 illustrating respective multiple tiles 522, 524, 526 presented to the user to allow the user to access one or more portions of extranet 330. Within this context, extranet 330 can allow the user to access one or more websites associated with authorized third-party institutions, such as banks, brokerages, insurance companies, or the like.

FIGS. 5G and 51 illustrate example webpages 528, 530 illustrating respective multiple tiles 532, 534 presented to the user to allow the user to access one or more portions of the intranet associated with the user. As shown, the tiles 532, 534 can provide access to end-of-life directives, repositories for government issued documents, insurance documents, deeds, titles, legal documents, or the like.

FIGS. 5J and 5K illustrate example webpages 536, 538 illustrating respective multiple tiles 540, 542, 544 presented to the user to allow the user to access one or more portions of extranet 330. Within this context, extranet 330 can allow the user to access one or more websites associated with authorized third-party institutions, such as banks, brokerages, insurance companies, cryptocurrency accounts, tax account information, or the like.

### Method

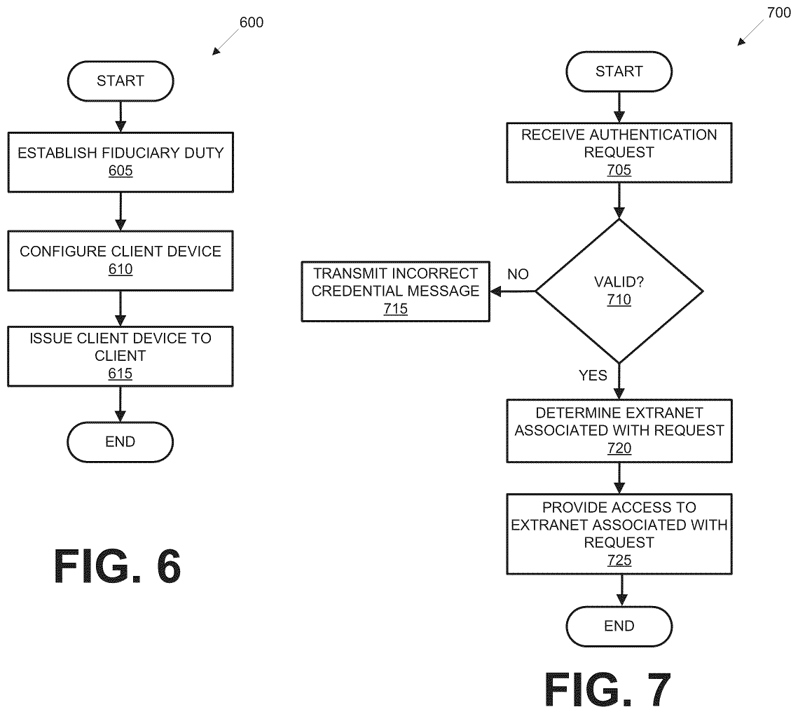

FIG. 6 is a flow chart of an example process 600 for distributing secure client devices 110 to one or more users. At block 605, a financial entity establishes a fiduciary relationship with a client.

At block 610, client device 110 is programmed, i.e., configured, such that client device 110 can establish communication with authorized third-party institutions via extranet 330 once a user has been authenticated. In some implementations, client device 110 is provided access to extranet 330 by specification platform 120 in response to authenticating credentials. For example, specification platform 120 can limit communications between approved third-party institutions via firewalls, URL redirects, and/or APIs. At block 615, client device 110 is issued to the client. The process 600 then ends.

FIG. 7 is a flow chart of an example process 700 for authenticating one or more client devices 110 and providing access to a particular extranet 330 based on the authentication. In some implementations, one or more process blocks of FIG. 7 may be performed by specification platform 120.

At block 705, an authentication request is received from client device 110. The authentication request can include user credentials, such as a user identification, a user password, a financial entity identification, a media access control (MAC) address of client device 110, and/or a portal identifier. At block 710, a determination is made whether the authentication request is valid. In some implementations, process 700 can include dual-factor authentication. If the authentication request is not valid, a message indicating the credentials are incorrect is transmitted to client device 110 at block 715.

Otherwise, at block 720, specification platform 120 determines which extranet 330 is associated with the validated authentication request. Specification platform 120 can include a data structure that stores authentication identifiers with extranets corresponding to particular third-party institutions. For instance, specification platform 120 includes a database that relates authentication identifiers, such as the portal identifier, to an extranet for a particular financial broker-dealer and/or financial institution. At block 725, specification platform 120 can provide access to the selected extranet 330. The process 700 then ends.

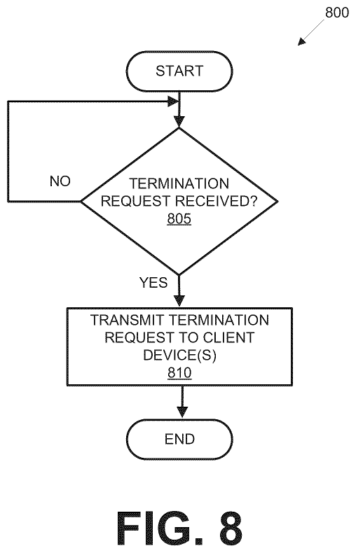

FIG. 8 is a flow chart of an example process 800 for disabling operation of client device 110. In some implementations, one or more process blocks of FIG. 8 may be performed by specification platform 120.

At block 805, a determination is made whether a termination request has been received. For example, termination of a licensing agreement between a financial broker-dealer and a financial entity may have occurred. Within this context, the licensing agreement corresponded to one or more client devices 110 provisioned to the financial entity from the financial broker-dealer. Upon termination, the financial broker-dealer can issue a termination request to specification platform 120.

If a termination request has not been received, the process 800 returns to block 805. Otherwise, at block 810, a termination command is transmitted to one or more client devices 110. In the example above, specification platform 120 can issue a termination command to one or more client devices 110 corresponding to the terminated licensing agreement. The termination command can cause the one or more client devices 110 to cease operation. In other words, the termination command can render all data on a hard drive of the one or more client devices 110 unreadable.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method for distributing at least one client device, the method comprising:
establishing a fiduciary relationship between a financial entity and a client;
programming the at least one client device such that the at least one client device is configured to establish communication with authorized third-party institutions via an extranet once the client has provided authentication credentials; and
issuing the client device to the client.

2. The method as recited in claim 1, wherein the at least one client device is configured to establish a secure communication channel with the financial entity.

3. The method as recited in claim 1, wherein the extranet is configured to access only webpages corresponding to the financial entity.

4. The method as recited in claim 1, wherein the at least one client device is configured to render all data on a hard drive of the at least one client devices unreadable in response to receiving a termination command.

5. The method as recited in claim 1, wherein the authentication credentials comprise at least one of a financial entity identification, a media access control (MAC) address of the at least one client device, or a portal identifier.

6. The method as recited in claim 5, wherein the financial entity identification comprises at least one of a financial broker-dealer, a financial broker, a financial dealer, or a financial adviser.

7. The method as recited in claim 1, wherein a specification platform is configured to prevent the at least one client device from accessing an unauthorized webpage via the extranet.

8. The method as recited in claim 7, wherein the specification platform is configured to redirect an unauthorized request from the at least one client device.

9. A method comprising:
receiving an authentication request from a client device;
determining whether the authentication request is valid;
determining at least one extranet associated with the authentication request after determining the authentication request is valid; and
providing access to the at least one extranet.

10. The method as recited in claim 9, further comprising:
accessing an authentication identifier stored in a data structure based on the authentication request; and
selecting the at least one extranet based on the authentication identifier.

11. The method as recited in claim 10, wherein the authentication identifier corresponds to the at least one extranet.

12. The method as recited in claim 9, wherein the at least one extranet corresponds to a financial institution.

13. The method as recited in claim 12, wherein the financial institution comprises at least one of a financial broker-dealer, a financial broker, a financial dealer, or a financial advisor.

14. The method as recited in claim 9, further comprising:
receiving a termination request; and
in response to the termination request, transmitting a termination command to at least one client device, wherein the termination command causes the at least one client device to cease operation.

15. A system comprising a computer including a processor and a memory, the memory including instructions such that the processor is programmed to:
receive an authentication request from a client device;
determine whether the authentication request is valid;
determine at least one extranet associated with the authentication request after determining the authentication request is valid; and
provide access to the at least one extranet.

16. The system as recited in claim 15, wherein the processor is further programmed to:
access an authentication identifier stored in a data structure based on the authentication request; and
select the at least one extranet based on the authentication identifier.

17. The system as recited in claim 16, wherein the authentication identifier corresponds to the at least one extranet.

18. The system as recited in claim 15, wherein the at least one extranet corresponds to a financial institution.

19. The system as recited in claim 18, wherein the financial institution comprises at least one of a financial broker-dealer, a financial broker, a financial dealer, or a financial advisor.

20. The system as recited in claim 15, wherein the processor is further programmed to:
receive a termination request; and
in response to the termination request, transmit a termination command to at least one client device, wherein the termination command causes the at least one client device to cease operation.
